(19) United States
(12) Patent Application Publication
(10) Pub. No.: US 2008/0288498 A1
(43) Pub. Date: Nov. 20, 2008

(54) Network-attached storage devices

(76) Inventors: Foster D. Hinshaw, Somerville, MA (US); John Chiu, Lexington, MA (US); Alan Potter, Newton, MA (US); Timothy J. Bingham, Westford, MA (US); Yongmin Chen, Wellesly, MA (US); Craig S. Harris, Acton, MA (US)

Correspondence Address: GOODWIN PROCTER LLP;PATENT ADMINISTRATOR, EXCHANGE PLACE, BOSTON, MA, 02109-2881, US

(21) Appl. No.: 12/152,420

(22) Filed: May 14, 2008

Related U.S. Application Data
(60) Provisional application No. 60/930,074, filed on May 14, 2007.

(51) Int. Cl. G06F 17/30; G06F 17/00; G06F 9/44

(52) U.S. Cl. 707/8; 707/104.1; 719/315; 707/E17.005; 707/E17.001

(57) ABSTRACT

Systems and methods for managing data within a networked computer environment including application servers and a plurality of storage devices utilize a collection of service modules, each separately addressable from and in communication with the application servers and the storage devices and providing system-wide services to the application servers and the storage devices.

### CROSS-REFERENCE TO RELATED APPLICATION

This application claims priority to and the benefits of U.S. provisional patent application Ser. No. 60/930,074, filed on May 14, 2007, the entire disclosure of which is incorporated herein by reference.

### FIELD OF THE INVENTION

This invention relates generally to systems for storing computer data, and more specifically to systems for managing storage and retrieval of record-oriented data between relational database management systems and network-attached storage.

### BACKGROUND

Network-attached storage (NAS) appliances allow multiple computers to share data storage devices, while offloading management and administration of the storage to the appliance. General-purpose NAS appliances present a file system interface, enabling computers to access data stored within the NAS in the same way that computers would access files on their own local storage.

A network-attached database storage appliance is a special type of NAS, used for storage and retrieval of record-oriented data used by a database management system (DBMS) that typically supports one or more applications. In such cases, the general-purpose file system interface is replaced with a record-oriented interface, such as an application that supports one or more dialects of a structured query language (SQL). Because the unit of storage and retrieval is a record, rather than a file, a network-attached database storage appliance typically controls concurrent access to individual records. In addition, the network-attached database storage appliance may also provide other management functions such as compression, encryption, mirroring and replication.

In a typical implementation, network-attached database storage appliances are used directly by a DBMS, and are invisible to database applications and users. The database applications and users send commands and queries directly to the DBMS, and need not know whether the records being manipulated reside in the local storage of the DBMS or within the NAS appliance. In addition, DBMSs often provide support for manipulating information that resides outside the DBMS. Standard data access and manipulation methods such as ODBC, OLEDB, XA/XOpen make otherwise separate data stores available to a DBMS. In certain implementations, relational DBMSs can use these standards and add support for SQL dialect translation, data type conversion and transaction coordination to make separate data stores appear as part of the DBMS. The result allows DBMS end users and applications to access separate data stores using APIs and facilities native to the DBMS.

In allowing remote data to be manipulated through native interfaces, DBMSs provide much of the support necessary for location transparency. But problems remain. While existing DBMS facilities may support manipulation of information outside the DBMS storage, they do not support transparent movement of information among multiple storage devices. Instead, database administrators are generally required to move information “by hand,” by copying it from one store to another and deleting it from the original store, resulting in extra work and application re-coding, as well as potentially introducing errors.

Different storage devices have different performance characteristics, different capacities, and different costs. Likewise, different sets of records in a database may have different requirements for performance, capacity and acceptable storage costs. The ability to relocate or co-locate records on different storage devices without visible impact to users or applications is important. For example, older records within a database may be accessed less frequently than more recently added records. Ideally, a DBMS would be able to move such records from a device that offers faster access at a higher cost, to a device that offers slower access but with more capacity and at a lower cost. Maintaining good performance for topical information while lowering storage cost for older information is important to database end users and to IT organizations.

Other problems plague database administrators as databases grow and merge. For example, a requirement to view data records that support disparate applications (e.g., inventory control applications and call-center applications) may be identified. In such cases, it is common that the two application use different database host applications (Oracle and DB2, for example), making integration difficult, especially when the data resides on NAS devices “under” different hosts. Rapidly expanding databases cause similar problems, as new hosts need to be brought online to operate in parallel with existing hosts, all sharing the same NASs as data sources.

Enterprise information integration systems try to address some of these problems by providing a layer on top of existing databases and information systems which abstracts their content and provides a single view. But in rising above existing databases, EII systems lose the authentication provided by the security systems of the existing databases, and they forgo the ability to directly interact with storage.

The challenges mentioned above are further exaggerated in so-called “massively parallel processing” (MPP) databases. Traditional MPP DBMS systems consist of three tiers. In the first tier, application programs issue database queries to one or more MPP host processors in the second tier. The MPP host processor parses and plans the queries, and distributes the plans to a number of NASs in the third tier. In this architecture, the MPP host processor relieves the application programs from having to manage the physical organization of the database in the third tier. From the application perspective, the host appears as an NAS, which just happens to delegate many of its responsibilities to a third tier.

The primary disadvantage of this three-tier approach is that the host has finite computational resources and is required to manage every data manipulation request being sent between the applications and each NAS. As the number of applications issuing concurrent queries grows, the host may exhaust its resources and be unable to keep up, becoming a scalability bottleneck.

While massively-parallel network-attached database storage holds promise for improving the performance and scalability of traditional database management systems, there is a need to solve the problems outlined above. Namely, moving data between the local DBMS storage and the NAS devices, accessing information stored in the NAS from multiple DBMSs, and relieving the bottleneck imposed by the middle tier of traditional MPP architectures.

### SUMMARY OF THE INVENTION

One way to obtain improved database performance while lowering overall storage costs is to facilitate the expansion of the entire data storage system (e.g., adding NASs and or hosts) and the reallocation of data without requiring users or applications to change how or where they look for data, and without the need for specialized hardware. Embodiments of the invention integrate network-attached database storage appliances with relational database management systems such that information can be added to, deleted from, and/or moved among one or more DBMSs and NASs without requiring any changes to or impacting the DBMS or applications. The invention further allows the expansion of an entire data storage solution with minimal or no interruption of service and in a manner completely transparent to the applications being serviced. The expansion can be “horizontal” (i.e., adding additional DBMS hosts), “vertical” (i.e., adding new NAS blades) or both. The invention may utilize views, triggers, partitions, synonyms and heterogeneous storage access to allow the transparent movement of information from one store to another, thus providing improved performance at lower overall storage costs. By segregating system-wide services from the storage devices, the number of storage devices and application servers may be scaled far beyond what is possible using conventional methods.

In a first aspect, the invention provides a system for managing data within a networked computer environment that includes application servers, plurality of storage devices in communication with and storing data in support of the application servers and a collection of service modules, each separately addressable from and in communication with the application servers and the storage devices. The service modules provide system-wide services to the application servers and the storage devices.

In some embodiments, the application servers host one or more applications such as database management servers and end-user applications (e.g., payroll, customer service, call records, and trading applications). In some cases, the application servers may be embedded within adapters between the database management servers and the storage devices. The storage devices may be network attached storage devices, which, in some cases, may also provide query transaction services for queries submitted to the application server. Examples of query transaction services include query parsing, query planning, query execution and combining of query results. Queries may include insert transactions, update transactions, delete transactions, retrieval transactions, or any combination thereof.

The service modules may comprise a transaction services module, a root services module, a blade services module, a lock manager services module, a catalog services module, and/or a database services module. Communication among the application servers and the service modules may, for example, be facilitated by application programming interfaces or other such software libraries. The transaction services module provides system-wide unique transaction IDs for transactions being processed by the system. The root services module provides the physical and logical location of each of the service modules (e.g., IP address, port), which may itself be discovered via a user datagram protocol (UDP) broadcast. The blade services module provides information such as addressing information (e.g., an IP address, a port number, a host id) and health information (on-line/off-line, etc.) for the storage devices. The blade services module also provides information about database instances located on the storage devices, such as connection information (e.g. a string used to connect to a database instance), and health information (on-line/off-line, etc.). The locking services module provides read-only, write-locking and transaction locking controls for data stored within the storage devices. The database services module provides information such as a mapping of logical data locations to physical locations on the storage devices. Such mappings may include the association of tables within the database (or databases) to physical storage devices, as well as a description of how data within the tables is allocated among the devices.

In some implementations, the system also includes an application-independent adapter residing on the application server that facilitates the transmission of data transaction messages directly to the storage devices, without the need to utilize a transaction processing monitor. The application-independent adapter may also be configured to combine transaction results received from each of the storage devices. In such cases, the system may also include an application-specific adapter for facilitating messaging between the applications and the application-independent adapter. In some implementations, the system also includes a separately-addressable transaction recording module for receiving messages from each of the storage devices requesting the creation of a persistent record indicating the completion of a transaction at the storage devices.

Another aspect of the invention relates to a method for executing a data manipulation and/or retrieval command (e.g., a query or transaction) in a data processing system. In a representative embodiment, a centralized transaction service module receives a request from an application to perform a data manipulation and/or retrieval command. The command may, in some embodiments, involve manipulating data stored on one or more storage devices, which, in some cases, may be network-attached storage devices within a massively parallel processing environment. A unique transaction ID is assigned to the request and direct connections are established between the application and each of the storage devices. The request to perform the command is transmitted using this connection such that the command is executed and the results transmitted back to the application. A “prepare transaction” message is sent from the application to each of the storage devices and durable records are created in the storage devices to indicate all changes resulting from execution of the command have been stored on a physical medium for subsequent reference. A confirmation message is transmitted from the storage devices to the application indicating the creation of the durable records, and forwarded from the application to a global transaction recording service indicating the command has been completed at each storage device. A persistent record of the completed command is created at the global transaction recording service.

Data manipulation and/or retrieval commands may include record insert transactions, record update transactions, record delete transactions and/or record retrieval queries. The unique transaction IDs may be retrieved from a data store or generated at the time of a request. Instructions to release resources previously allocated to the execution of the command are transmitted from the application directly to each of the storage devices.

In another aspect, the invention provides a system for managing data within a networked computer environment. Embodiments of the system include one or more application servers (each application server may have one or more applications operating thereon) and a plurality of storage devices in communication with the application servers. The storage devices include physical storage disks for storing data supportive of the applications. The system also includes two adapters—an application-independent adapter residing on the application server and facilitating the transmission of data transaction messages directly to the storage devices, and an application-specific adapter for facilitating messaging between the applications and the application-independent adapter.

The applications may include, for example, database management systems, and/or user-facing applications such as payroll processing, call center management, trading systems, etc. The storage devices may be network attached storage devices.

In embodiments in which the applications use different syntaxes for transmitting the data transaction messages to the storage devices, the application-specific adapter translates the different syntaxes into a common message syntax, thereby allowing the system to service data requests from heterogeneous applications using common data storage devices. The application-independent adapter may be further configured to parse data transaction messages into message components, such as a “from” or “where” clause within a structured query language query. In some embodiments, the application-independent adapter may determine the distribution of data among the storage devices, thereby facilitating the delivery of data transaction messages to the storage device or devices having the requested data. In still other embodiments the application-independent adapter is configured to combine query results received from each of the storage devices.

In another aspect of the invention, a method for migrating data from a symmetric multiprocessing (SMP) data store to a massively parallel processing (MPP) data store includes defining a view within the SMP data store referring to a table within the MPP data store and issuing a single data transaction message against the SMP data store. The single transaction selects records from the SMP data store and substantially simultaneously inserts the selected records into a table within the MPP data store via the view.

The MPP may include multiple network attached storage devices, and in some instances the table within the MPP is distributed among more than one of the network attached storage devices.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1 and 1A are block diagrams of relational databases and network attached database storage appliances as configured in a conventional implementation of network attached storage appliances.

FIG. 2 is a block diagram of relational databases and network attached database storage appliances as configured in accordance with one embodiment of the present invention.

FIG. 3 is an alternative block diagram of relational databases and network attached database storage appliances as configured in accordance with one embodiment of the present invention.

FIG. 4 is a flow chart illustrating the steps in discovering system components for transaction and query processing in accordance with one embodiment of the invention.

FIG. 5 is a flow chart illustrating the steps in processing data transactions in accordance with one embodiment of the invention.

### DETAILED DESCRIPTION

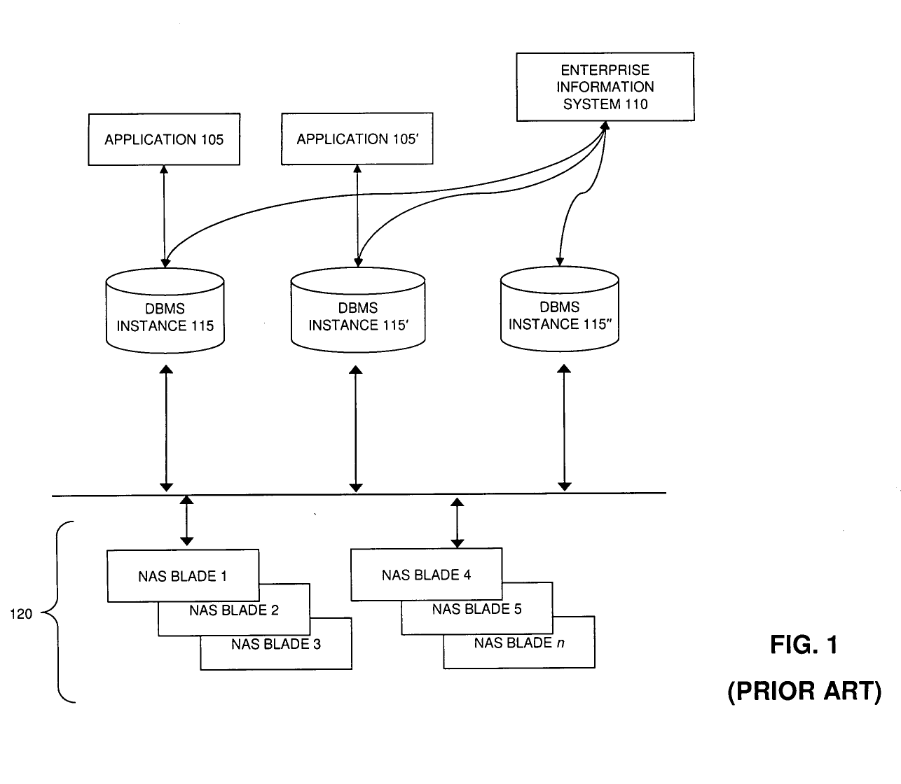

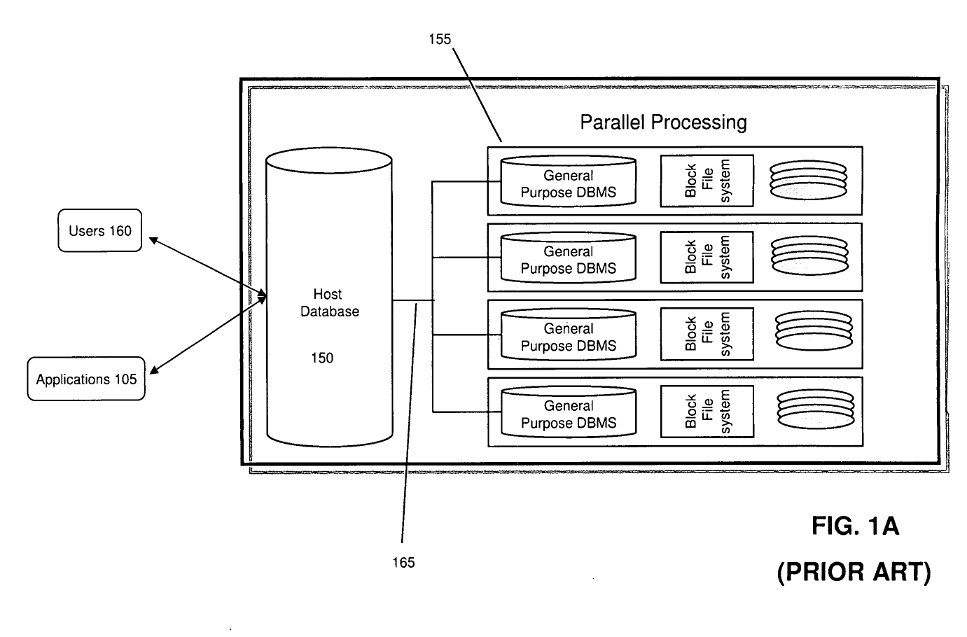

Referring to FIG. 1, applications 105 and 105′ (generally 105) and enterprise information systems 10 utilize or more database management systems (DBMS) 115, 115′ and 115″ (generally 115) to provide data, configuration information, and user permissions. In certain cases, a single DBMS instance 115 may support a single application 105, whereas in other cases, many applications 105 may rely on one DBMS 115. Frequently, enterprise information systems 110 utilize data from numerous applications (combining data from sales systems, inventory systems, and financial systems into a single executive-level performance dashboard, for example). As used herein the term “applications” may refer to any type of application that uses and/or manipulates data, including enterprise information systems 110. The number and type of applications 105 can vary widely, and include both transactional-based applications (e.g., trading systems, customer service systems, etc.), business intelligence and data mining applications, and database management systems themselves.

Similarly, the number and type of DBMS 115 may differ widely from implementation to implementation, some using only a single instance of an DBMS 115 while others may include numerous instances. In some cases, an implementation may include DBMS′ from different vendors. In typical implementations, the applications 105 may reside solely on a client machine and interact with a database server on which the DBMS operates, while in other implementations portions of the applications may reside on an application server that provides the operational instructions, application screens, and/or data to client devices. Examples of DBMS systems that provide such functionality include the SQLServer Database Server by Microsoft Corporation, the DB2 Database Server by IBM, and the ORACLE Database Server offered by ORACLE Corporation.

In large-scale implementations of data-intensive computer applications, multiple data storage devices 120 (also referred to as network attached storage (NAS) appliances or “blades”) may be used to provide additional storage in support of the DBMS 115 and applications 105. In conventional implementations, each DBMS 115 is configured such that when presented with a data manipulation instruction (e.g., select, insert, delete, update) from an application 105, the DBMS 115 queries the correct blade 120 for the requested data. Further, centralized DBMS services are located on one physical host as part of the DBMS itself. As such, all query planning, processing and optimization functionality is required to pass through this single host prior to the distribution of queries across the distributed blades 120. This single point of processing creates a bottleneck and limits scalability. Because some of these services are DBMS-specific, changing the configuration of the storage array (e.g., replacing the DBMS, adding new blades, redistributing data among blades) requires significant effort.

This bottleneck becomes even more prominent when implementing a massively parallel storage system. FIG. 1A illustrates one conventional approach for providing massively parallel storage. The approach includes providing a host database component 150, often referred to as a query coordinator, and a plurality of data server components 150. End users 160 and applications 105 submit data requests and updates to the host database component 150, which distributes queries among the data server components 150 based on the location of the requested data. The requested data may reside in a block file system, on disk, or some combination thereof. The host database component 150 is also responsible for managing transactions, record locking, the catalog, and various other administrative functions.

In such an arrangement, all query processing and administrative functions must pass through the host 150, thus creating a performance bottleneck 165 and a single point of failure. In some instances the bottleneck may be the host itself, as it has a finite amount of memory, CPU and other processing capabilities. As the number of users 160 and applications 105 grow, so grows the load on the host 150. While replicating the host 150 such that each host can access each data server 150 may alleviate the load and single-point of failure problems the transaction, locking, catalog and administrative functions performed by the replicated hosts must be synchronized, creating a significant administrative burden.

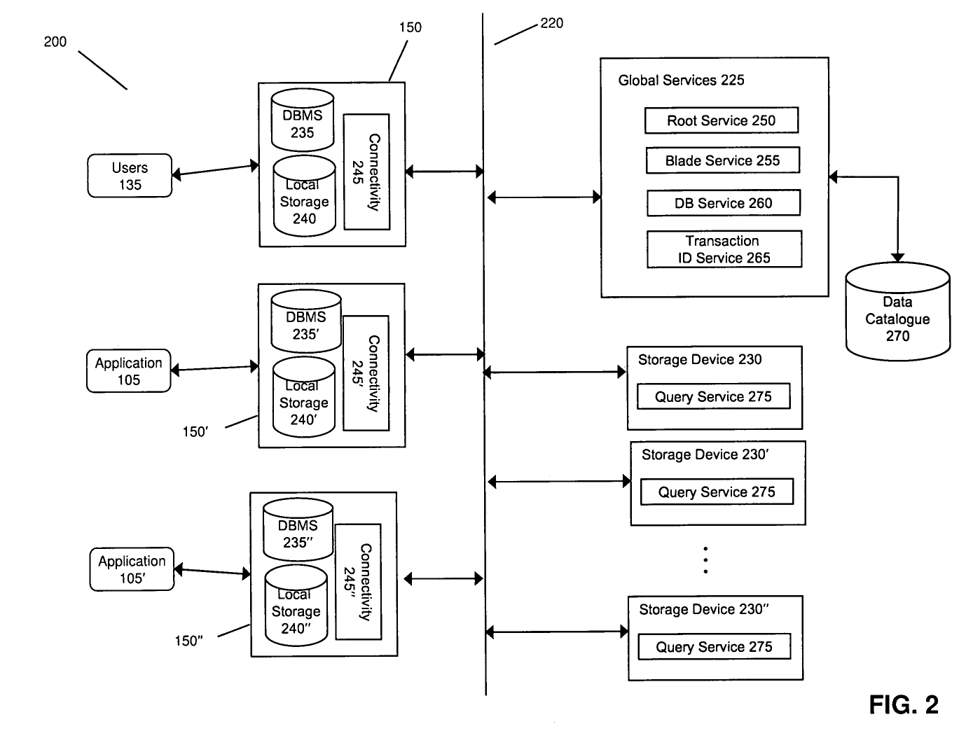

Referring now to FIG. 2, various embodiments of the invention provide a system 200 and associated techniques addressing these problems by providing one or more database hosts 150, a global services module 225 and one or more data storage devices 230 (such as NASs or blades) that together provide a scalable and flexible massively parallel data storage solution by strategically locating certain system functions within the system 200. In some instances, the database hosts 150 include a DBMS application 235 (e.g., Oracle), local storage 240 (e.g., disks) and connectivity software 245. In other implementations, a communications network 220 connects the hosts 150 to the global services module 225 and the storage devices 230. The communication may take place via any media such as standard telephone lines, LAN or WAN links (e.g., T1, T3, 56 kb, X.25), broadband connections (ISDN, Frame Relay, ATM), wireless links, and so on. The type of network is not critical, however, and any suitable network may be used. Typical examples of networks that can serve as the communications network include a wireless or wired Ethernet-based intranet, a local or wide-area network (LAN or WAN), and/or the global communications network known as the Internet, which may accommodate many different communications media and protocols.

Information and transactions processed by the hosts 150 may be divided into distinct categories based on the frequency and computational load of each such that each category can be serviced separately by different functional components of the system 200. By dividing the information typically processed by the hosts 150 into two distinct categories and by using different processing techniques for the two categories of information, scalability and flexibility can be achieved without having to designate a single host as a “controlling” or “centralized” host or to duplicate or synchronize information and services among multiple hosts.

The first category, global information and processes, includes services that are applicable across the entire system and are accessed or changed relatively rarely, such as the network addresses of the system components, whether the components are functioning, and how to address them. Global information may also include information about the commitment status of transactions, the system catalog and the distribution method used to divide data across the storage devices 230. The second category of information, local information, relates to work being performed on behalf of a particular application or storage device, such as individual query processing. This information is local, not global, its relevancy is short lived, and it changes quickly and frequently in comparison to global information. As such, the global services module 225 provides a set of services that attend to the global and slow-changing information and makes these services available to all components of the system. These services are separate and distinct from the host servers 150, applications 105 and storage devices 230 and are uniquely and separately addressable by the other system components. In one particular example, each service may be assigned a unique IP address and port number, which is used as a destination for requests to these services. Connection strings (containing, for example, IDs and passwords) may be used instead of or in conjunction with IP addresses and port numbers to identify and connect to system components. Further, because this information changes slowly, the global services module 225 can be replicated without incurring significant synchronization penalties, as would be the case in replicating such services across multiple host. Communication among the hosts 150, applications 105 and the services provided in the global services module 225 may be facilitated through application programming interfaces (APIs) or similar software libraries located on the hosts 150 and/or within the service 235-250.

In some embodiments, certain query and transaction coordination functions that would typically be performed by the host (e.g., query parsing, query planning, query distribution, result aggregation, etc.) are instead performed by query services components 275, which may be located at each storage device 230 or a subset thereof. In some cases, the hosts 150 send each query or transaction to each storage device 230, whereas in other implementations only a subset of the devices 230 receive instructions to perform the transaction. In one embodiment, separate client connectivity modules 245 are provided within each host 150. Maintaining separate connectivity modules 245 allows the front-end application 105 to scale in conjunction with increasing numbers of users, while the back-end scales according to the increasing amounts of data. For example, in one embodiment, each connectivity module 245 contains its own database, which may be used to parse and plan queries, and to aggregate results returned by the storage devices 230. In another embodiment, the connectivity modules 245 delegate the parsing and planning to one or more of the storage devices 230, but then controls the execution and aggregation of results.

More specifically, the location of the various shared DBMS services within a host-independent global services module 225 frees any of the hosts 150 from having to perform system-wide process. These services include root services 250, blade services 255, database services 260, transaction ID services 265, a catalog manager 270 and a lock manager (not shown).

The root service 250 maintains information on how hosts 150 or storage devices 230 contact the modules within the global services 225. In one embodiment, the root service 250 is physically located on one of the storage devices 230 and known to all hosts 150. In another embodiment the root service 250 may be physically located on one of the storage devices 230 and is discovered by the hosts 150 via a broadcast request. In another embodiment, the root service 250 may be located on a computing device separate from the storage devices 230, and accessible over the network 220. In a fourth embodiment, the root service 250 may be replicated on a number of computer devices, possibly including storage devices 230. In one particular embodiment, a requesting host 150 or application 105 issues a user datagram protocol (UDP) broadcast, looking for a root service for a desired database. In some cases, there may be a numerous root services defined on the network 220, and the root service that answers the broadcast may not be the root service for its desired database. However, because the root service answering the request has a priori knowledge of other root services available to the network, it can provide the requesting host 150 or application 105 with the IP address and port of the root service that does have knowledge the location of its desired database.

In one embodiment, all of the global services 225 are co-located with the root service 235. In another embodiment, each global service component may reside on a different physical component, so as to distribute the computational costs of using the global services 225. In such cases the global services module 255 may exist only as a logical entity comprised of the various service modules. In one embodiment, the information maintained by each global service is held in a database.

The blade service module 255 provides information about which of the data storage devices 230 are functioning properly, information about their network address, and in some cases a listing of the database instances instantiated on each storage device 230. The blade services module 255 may also record the health status of both the physical storage device 230 and the health status of all database instances running on the physical storage device (referred to as “dbnodes”). For example, if the device is powered up and answering requests at its IP address and port, then its status would be designated as “up”. If a database process (software) running on the physical storage device had crashed, its status would be “down.” The IP address and port number are used to connect to the physical storage device, and a connection string (which may include a user ID and password) is used to connect to the particular database instances running on the device 230.

The database service 260 maintains information about how the contents of tables are distributed across the devices 230. The transaction ID service 265 maintains information about the commitment status of database transactions that may span one or more of the storage devices 230. This service provides functions such that report the commitment status of a transaction. The transaction ID server 265 also provides unique transaction identifiers for use by the hosts 150 and the storage devices 230. In one embodiment, an ID service (not shown) provides 32-bit and 64-bit identifiers. In one embodiment, these identifiers are used to identify transactions and database tables and client queries.

The catalog manager 270 provides a single view of the database schema. In one embodiment this includes information about tables, their columns and data types and their indices, as well as the locations of tables among the storage devices 230. For example, the logical data locations may include the names or identifiers of tables, along with a description of how the tables are distributed across storage devices 230. The description may indicated, for example, that the table is mapped to a single storage device, that the table is replicated on each storage device (so-called “All” distribution), that records of the table are distributed randomly or in round-robin fashion across storage devices, or that attributes in the records of the table are used to determine their target storage device. The description may also indicate that the physical location of data includes a slice identifier mapped to a primary storage device, and in some cases to a secondary storage device should the primary storage device be unavailable. This information is helpful when parsing a query and planning its execution across multiple devices.

The lock manager controls concurrent execution of queries across storage devices 230, and detects cross-device deadlock situations. In some cases, the lock manager provides the ability to lock data within the storage devices 230 in a variety of locking modes, such as “for-reading” or “for-writing” on behalf of a requesting data manipulation command.

As such, the present invention distributes certain functions of the individual DBMSs among different physical components in a manner that allows the storage devices to operate independently of but still support the use of any number of DBMSs. The result is an array of portable and massively parallel storage devices (such as NASs) that are attachable to an existing DBMS installation, regardless of vendor, operating system and configuration.

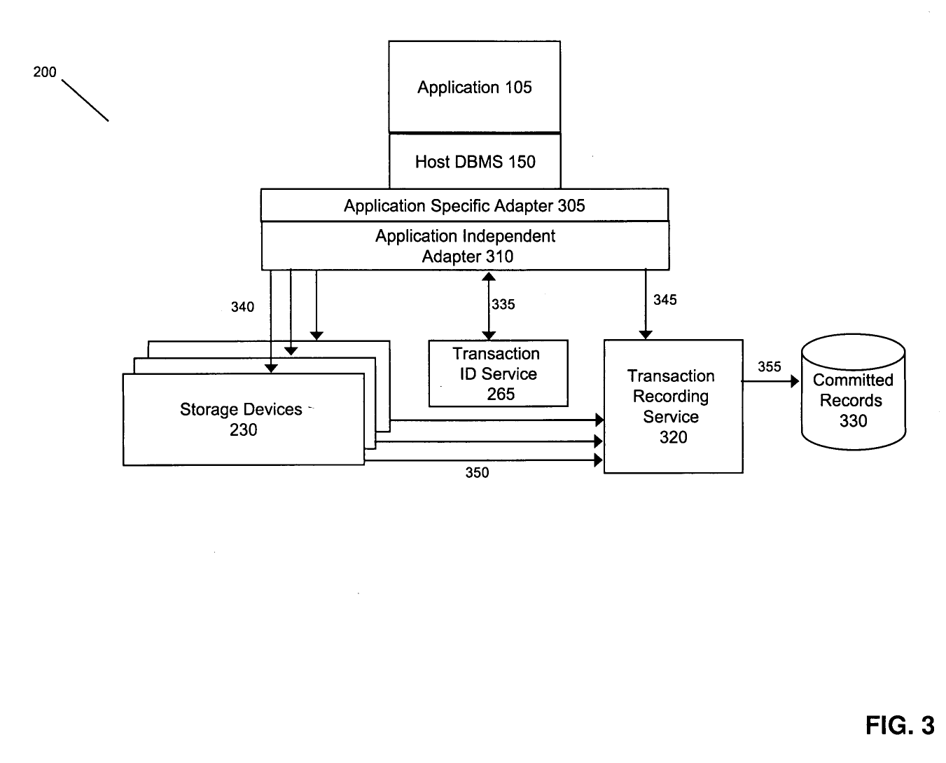

Referring to FIG. 3, the independence (or sometimes referred to as “transparency”) of the storage devices 230, the applications 105 and the DBMS hosts 150 is facilitated by a “connector” or “adapter” (e.g., such as an API or other addressable interface) that is added to each instance of an application or DBMS host. In some implementations, different adapters (host-specific adapters) 305 may be used for different DBMSs, and an application-independent adapter 310 may be used to facilitate messaging among the application-specific adapter 305, the storage devices 230, and the global services modules. The connector may be embedded with drivers such as ODBC, JDBC, and/or ADO to facilitate communication between the applications 105 and the storage devices 230. For example, the connectors translate data manipulation requests received by the database applications into the specific dialect of SQL understood by the device being addressed. The adapters may also coordinate transactions among the database management systems and the storage devices using a two-phase commit protocol in which certain query steps are distributed to and performed on individual devices, while the results of each step are aggregated or combined at a central location to provide a complete result set.

Still referring to FIG. 3, the transaction ID service 265, in conjunction with a transaction recording service 320 and committed records database 330 provides a separately-addressable module that allocates unique transaction IDs for tracking data manipulation commands within the system 200. In doing so, the system provides scalable transaction processing without having to rely on a single transaction processing monitor within a host database management system. In practice, the host 150 requests a transaction ID for each new query or transaction from the transaction ID service 265 (message 335). Once issued, the application 105 uses the transaction ID to communicate directly with the storage devices 230 (messages 340). Messages may include, for example, a begin transaction message, a prepare transaction message, a commit transaction message and/or a rollback transaction message. In contrast, conventional methods require each transaction message to be processed by a central transaction manager prior to being sent to the individual storage devices. Once the application is informed the transactions are complete at the storage devices, a message is sent to the transaction recording service 320 (message 345) indicating the transaction has completed, and a durable record of the transaction may be written to disk 330. At any time, storage devices 230 may request commit status of a transaction from the transaction recording service 320 (message 350). In each instance, the application adapters facilitate messaging among system components regardless of the application 105, DBMS host 150 or location or type of storage devices 230.

In some embodiments, the aforementioned system architecture facilitates rapid data migration among databases, distribution of queries among storage devices and the aggregation of query results from multiple storage devices in massively parallel processing (“MPP”) databases.

To facilitate the transparent movement of data and expansion of storage within the system, queries and transactions operate against views that access data regardless of its storage location in the DBMS or in the array of storage devices. For example, a typical query to retrieve a record from a database may be of the form:
SELECT * FROM mytable WHERE keyvalue=27.

If the desired record(s) reside outside the DBMS, the above query may take the form:
SELECT * FROM mytable@my_storage WHERE keyvalue=27

The “@my_storage” moniker informs the DBMS that the data resides outside the DBMS at a device named “my_storage.” The addition of the device-specific moniker, however, makes it difficult for database applications to manipulate data that may be stored in the DBMS or any number of individual appliances. For example, if a record in the table mytable is included in the DBMS's local storage at one time, and is subsequently moved to a network attached storage appliance, applications are instructed to use the second query instead of the first to in order to manipulate the same data.

In one particular embodiment, data migration from symmetric multiprocessing (“SMP”) databases (“MPP”) databases is achieved all within the functional confines of the SMP database without the need for external tables, temporary files or multi-step commands. Using the adapters provided above, a view may be defined within a SMP data store referring to a table within the MPP data store. A single SQL command may then be issued against the SMP to simultaneously select records from a table within the SMP and insert the records into the table within the MPP. In some cases, the destination table may be distributed among more than one network storage device.

Regarding the distribution of queries and aggregation of query results, the application-independent adapter uses information from the global services module to determine which storage devices queries (or query segments) should be sent.

For example, given a table definition such as “CREATE TABLE my_table (col1 CHAR(10), col2 INT)”, the adapter processes insertion statements such as “INSERT INTO my_table VALUES(‘abc’, 10)” depending on the distribution method chosen for the table. For cases where the table is located on a single storage device, the adapter sends the query to that device. For cases where the table is replicated across a set of two or more devices, the adapter replicates the insert query, sending it to each of the devices containing the replicated table. For cases where the table uses round-robin distribution, the adapter sends the insert query to the connection chosen for round-robin distribution, and advances that connection to the next connection. For subsequent inserts, the connections are used in order. Once the last connection is used, the application starts over with the first connection. Finally, for hashed distribution, the adapter uses a distribution map retrieved from the database service. In such cases, the adapter computes a hash function of particular columns, takes the result modulo the size of the distribution map, and uses the residue to index into the map. The value there is used as the index of the device connection to which the insert query will be sent.

In some embodiments the application-independent adapter divides and rewrites queries received from the application-specific adapter into two portions—a portion evaluated in the application-independent adapter and a portion distributed to the storage devices for processing thereon. As an example, in processing SELECT queries such as:

1. SELECT * FROM my_table;
2. SELECT * FROM my_table ORDER BY col1; and
3. SELECT max( col1 ), count(*) FROM my_table

the application-independent adapter computes three auxiliary queries for each user-supplied query. The first of these is the query that will be sent to each applicable storage device. The second of these is a “create view” statement whose purpose is to combine the results of each device. The third of the auxiliary queries is an aggregation selection that gets results from the view defined by the second auxiliary query. For the first two SELECT queries above (1, and 2), the view (2^{nd} auxiliary) is:

CREATE VIEW results_view AS (SELECT * FROM blade1_query
UNION
ALL SELECT * FROM blade2_query ... UNION ALL
SELECT * FROM bladeN_query)

where blade1_query through bladeN_query are the first of the auxiliary queries, and where there is one such query for each of N storage devices.

Given this, for the first query, the auxiliary blade query is: “SELECT * FROM my_table”

and the auxiliary aggregation selection is “SELECT * FROM results_view”.

For the second query, the auxiliary blade query is “SELECT * FROM my_table”, and the auxiliary aggregation selection is “SELECT * FROM results_view ORDER BY col1”

For the third query, the CREATE VIEW auxiliary query would be similar to the one used for the first two queries, but the columns would be named as follows:

CREATE VIEW results_view (results_col1, results_count) AS
(SELECT * FROM blade1_query UNION ALL SELECT * FROM
blade2_query ... UNION
ALL SELECT * FROM bladeN_query),

and the blade query would be:

“SELECT max(col1) AS results_col1, count(*) AS results_count FROM
my_table”; and the auxiliary aggregation selection is “SELECT
MAX(results_col1), SUM(results_count) FROM results_view”.

It is notable here that the aggregation selection query computes the maximum of the maximums and sums the count(*) results retrieved from each storage device.

In addition to the application-independent adapter and global services components, a data management console allows users to view and manage the storage devices independent of the DBMS serviced by the devices. The functions supported by the management console include:
1. Defining relevant configurations of devices
2. Creating, Altering, Dropping tables
3. Delegating tables to devices, defining their distributions
4. Configuring the databases running on each device
5. Retrieving logs of information generated on each device
6. Retrieving information about queries being processed
7. Displaying statistics about devices uptime, query throughput, disk I/O, CPU usage, network usage, memory usage.
8. Performing routine maintenance functions such as backups

The architecture and arrangement of the various components described above allow for differing distributions of data across the DBMS and storage devices. For example, a 10%-100% distribution occurs when 100% of the data historically inserted into the DBMS is also copied to a storage device, but subsequently, 90% of the older data is deleted from the DBMS, leaving only the most recent 10% in the DBMS local storage. The values 10% and 90% are chosen here for illustrative purposes to indicate that the DBMS actively stores only a small portion of the total information originally entered. In actual practice, the percentage may change over time, in accordance with choices about the definition of topical versus historical information, and may well be closer to a 1%-99% distribution.

A 10%-90% distribution occurs when the DBMS copies data that it deletes from its local storage to the storage device. Initially, 100% of the data will generally reside in the DBMS. Over time, as historical information is removed from the DBMS, it is added to the devices so that the DBMS stores topical information and the devices store historical information. As time passes, the preponderance of the total information that has been added to the DBMS will come to reside on the storage devices, but the most recent topical information will be stored in the DBMS and not on the devices. As above, the values 10% and 90% are chosen for illustrative purposes, and in actual practice the percentages will vary and likely be closer to 1% and 99%.

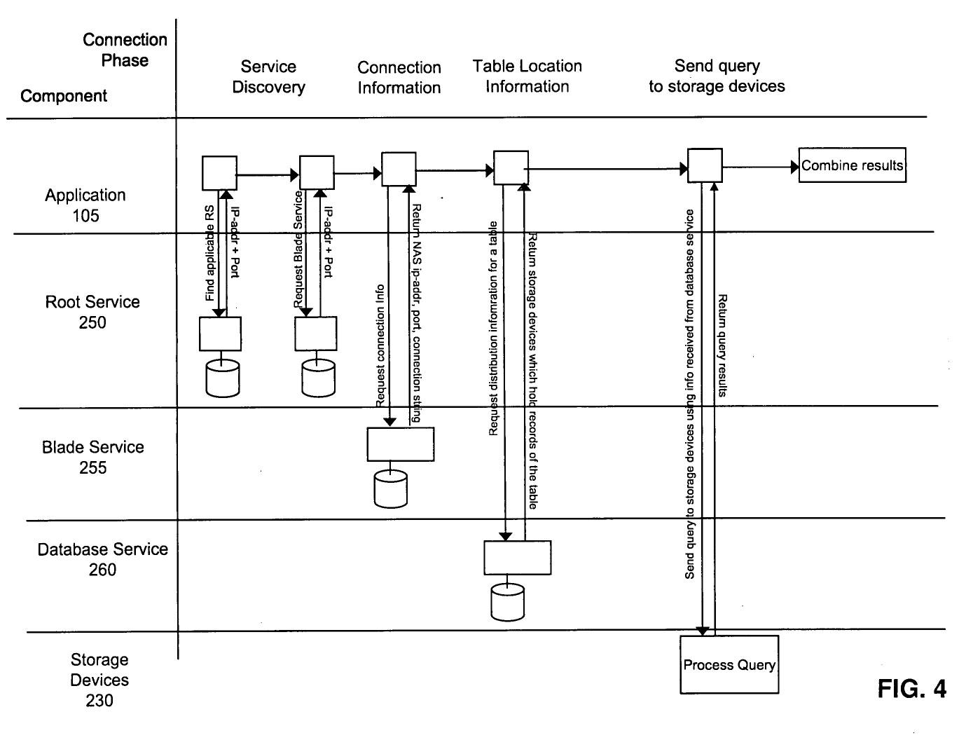

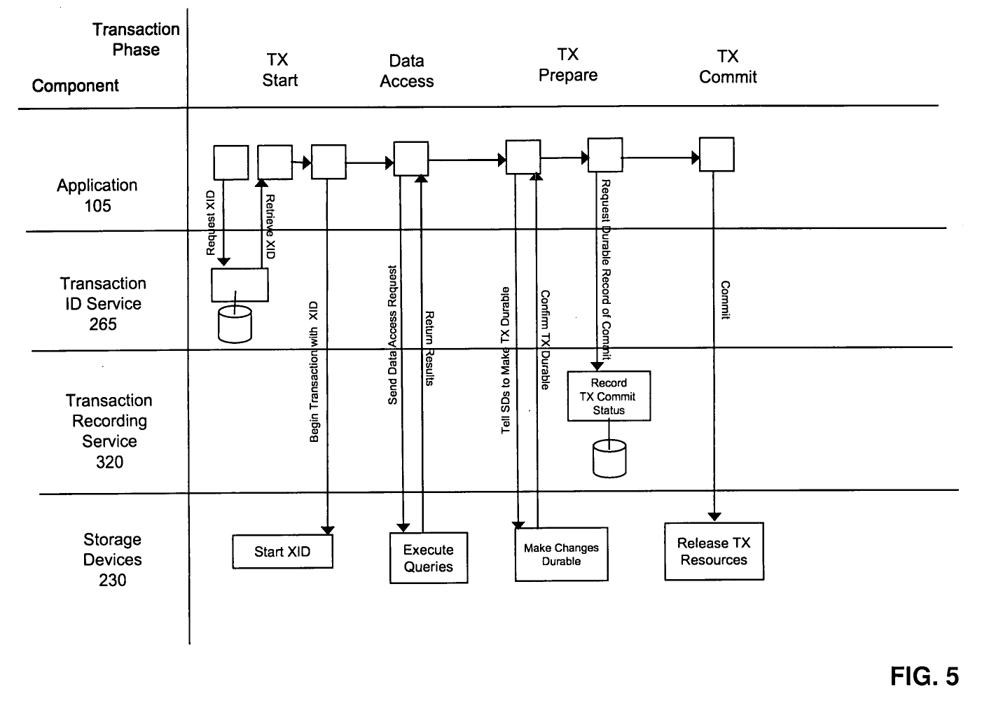

Referring now to FIGS. 4 and 5, a more detailed description of a component discovery and execution of a data manipulation command is illustrated.

The application 105 (either an end-user application having a application-specific adapter or a database host) contacts the global services module, requesting connection information used to contact the transaction ID service 215, the blade service, and the transaction recording service 220. In one embodiment, this information comprises the IP addresses and ports assigned to these components.

The application 105 uses this connection information to contact the blade service 255, requesting connection information for each storage device 230. In one embodiment, this information comprises the IP address and port of each storage device 230, plus a connection string (e.g., an authentication identifier and/or password) that can be honored by each device. In one embodiment, this information is held in a global service database, comprising tables that describe each device and each physical computing device on which the devices are hosted. In one particular embodiment, the table describing the storage devices includes: (i) a connection string used to connect to the device, (ii) a status indicator of whether the device is active and able to respond to requests, (iii) an identifier of the database system of which the device is part, (iv) a unique identifier of the device itself, and (v) an identifier of the physical computing device hosting the device. Similarly, a table describing the physical computing devices may include, for example, (i) an IP address, (ii) a port, (iii) a status indicator of whether the computing device is turned on and can receive requests at its IP address and port, (iv) an identifier of the database system of which the physical computing device is a part, and (v) an identifier of the physical computing device. The application 105 uses the connection information provided above to establish connections with the devices 230 needed to complete the transaction, and the information from the root services module to request a transaction identifier from the transaction ID service 215.

The transaction ID service 215 responds with a unique transaction identifier. In a one embodiment, the transaction identifier is a 64-bit number that increases monotonically. Other embodiments may use strings of arbitrary length. In certain implementations, the transaction identifier uses information held in a global service database to ensure that the identifiers it provides are unique.

The application uses the connection information described above to send each storage device a “begin transaction” message, passing the unique transaction identifier that was provided by the transaction ID service 265. The application may then, in some cases, query the storage devices and create new information, modify existing information, or delete existing information in some or all of the devices based on the specifics of the transaction.

After the transactions have completed, the modifications effectuated during execution can be made persistent. This comprises two logical steps: a “prepare” step and a “commit” step. In the “prepare” step, the application 105 sends a “prepare” message to each of the devices 230 that were involved in executing the transaction that includes the unique transaction identifier. Each device 230 receives the prepare message, and makes any changes durable. The device 230 also makes durable a record of the fact that it has created a durable record of the transaction. The device 230 then sends a message back to the application indicating that it has successfully prepared the transaction.

Upon receiving confirmation that each device has successfully prepared the transaction, the application 105 uses the connection information to contact the transaction recording service, providing it with the unique transaction identifier and instructing it to make a durable record of the fact that the transaction identifier has committed. It then acknowledges that the transaction is committed. The application 105 then sends a “commit” message to each of the devices 230 that were included in the transaction identified with the unique transaction identifier.

Each device 230 receives the “commit” message and releases resources associated with the committed transaction. In one embodiment, the device 230 also notes that the status of the transaction identified by the transaction identifier has changed from “prepared” to “committed.” In one embodiment, this status change is made durable by, for example, deleting the record that the transaction was locally prepared by the device 230.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for managing data within a networked computer environment, the system comprising:
one or more application servers, each capable of running one or more applications thereon;
a plurality of storage devices each in communication with at least one of the application servers and comprising a plurality of physical storage disks for storing data supportive of the applications; and
a plurality of service modules, separately addressable from and in communication with the application servers and the storage devices, each service module providing system-wide services to each of the application servers and each of the storage devices.

2. The system of claim 1 wherein the application servers comprise database management host servers.

3. The system of claim 2 wherein the application servers are embedded within adapters between the database management host servers and the plurality of storage devices.

4. The system of claim 1 wherein the storage devices comprise network-attached storage devices.

5. The system of claim 1 wherein the service modules comprise one or more of a transaction services module, a root services module, a blade services module, a lock manager services module, a catalog service module and a database services module.

6. The system of claim 5 wherein the application servers communicate with the service modules via an application programming interface.

7. The system of claim 5 wherein the transaction services module provides system-wide unique transaction ids for transactions being processed by the system.

8. The system of claim 5 wherein the locking services module provides locking of data records stored on the storage devices.

9. The system of claim 8 wherein locking comprises one or more of read-only locking, write-locking, and transaction locking.

10. The system of claim 5 wherein the root services module provides information to the application server comprising the physical and logical location of each of the service modules.

11. The system of claim 10 wherein the physical and logical location of each of the service modules is transmitted to the application server in response to a User Datagram Protocol broadcast.

12. The system of claim 5 wherein the blade services module provides information to the application server comprising addressing information for the storage devices.

13. The system of claim 12 wherein the blade service module further provides information to application server comprising instances of databases attributed to each of the storage devices and whether the instances are operational.

14. The system of claim 12 wherein the addressing information comprises one or more of an IP address, port number, host id and a connection string.

15. The system of claim 5 wherein the blade services module provides information to the application server comprising information regarding the health of the storage devices

16. The system of claim 5 wherein the database services module provides information to the application server comprising catalog information.

17. The system of claim 16 wherein the catalog information comprises a mapping of logical data locations to physical locations on the storage devices.

18. The system of claim 17 wherein the mapping comprises (i) a mapping of tables to the one or more storage devices on which data allocated to the tables are physically stored, and (ii) a description of how the data is allocated among the one or more storage devices.

19. The system of claim 1 further comprising an application-independent adapter residing on the application server and facilitating the transmission of data transaction messages directly to the storage devices.

20. The system of claim 19 further comprising an application-specific adapter for facilitating messaging between the applications and the application-independent adapter.

21. The system of claim 20 wherein the application-independent adapter is configured to combine transaction results received from each of the storage devices.

22. The system of claim 1 wherein each storage device further comprises query transaction services for processing queries submitted by the application server, the query transaction services comprising query parsing services, query planning services, query execution services and query result aggregation services.

23. The system of claim 22 wherein the queries comprise one or more of insert transactions, update transactions, delete transactions and retrieval transactions.

24. The system of claim 1 further comprising a separately-addressable transaction recording module for receiving messages from each of the storage devices requesting the creation of a persistent record indicating the completion of a transaction at the storage devices.

25. A method for executing a transaction in a data processing system, the method comprising:
receiving, at a centralized transaction service module, a request from an application to perform a transaction involving data stored on one or more of a plurality of storage devices;
associating a unique transaction ID to the request;
establishing direct connections between the application and each of a plurality of storage devices and transmitting the request to perform the transaction thereon;
executing the transaction at one or more of the storage devices;
transmitting results of the transaction to the application;
transmitting a prepare transaction message from the application to each of the storage devices;
creating durable records based on the results of the transaction at each storage device;
transmitting a confirmation message from the storage devices to the application indicating the creation of the durable records;
transmitting the unique transaction ID from the application to a global transaction recording service, indicating the transaction has been completed at each storage device; and
creating a persistent record at the global transaction recording service indicating the transaction has been committed.

26. The method of claim 25 wherein the transaction comprises one of a record insert transaction, a record update transaction, a record delete transaction or a record retrieve transaction.

27. The method of claim 25 wherein the unique transaction IDs are retrieved from a central data store.

28. The method of claim 25 wherein the durable records are created in non-volatile storage.

29. The method of claim 25 further comprising transmitting instructions from the application directly to each of the storage devices to release resources previously allocated to the transaction.

30. A system for managing data within a networked computer environment, the system comprising:
one or more application servers each capable of running one or more applications thereon;
a plurality of storage devices each in communication with at least one of the application servers and comprising a plurality of physical storage disks for storing data supportive of the applications;
an application-independent adapter residing on the application server and facilitating the transmission of data transaction messages directly to the storage devices; and
an application-specific adapter for facilitating messaging between the applications and the application-independent adapter.

31. The system of claim 30 wherein the applications comprise database management systems.

32. The system of claim 30 wherein the storage devices comprise network attached storage devices.

33. The system of claim 30 wherein the applications use different syntaxes for transmitting the data transaction messages to the storage devices, and the application-independent adapter translates the different syntaxes into a common message syntax, thereby allowing the system to service data requests from heterogeneous applications using common data storage devices.

34. The system of claim 30 wherein the application-independent adapter is configured to parse data transaction messages into message components.

35. The system of claim 34 wherein the message components comprise a where clause from a structured query language query identifying a subset of the storage devices to which the data transaction commands are to be sent.

36. The system of claim 34 wherein the message components comprise a from clause from a structured query language query identifying a subset of tables from which to select data records, thereby facilitating the transmission of the data transaction command to the storage devices on which the subset of tables resides.

37. The system of claim 30 wherein the application-independent adapter is configured to determine a distribution of data among the storage devices, thereby facilitating the delivery of data transaction messages to a storage device having data related to the data transaction message.

38. The system of claim 30 wherein the application-independent adapter is configured to combine transaction results received from each of the storage devices.

39. The system of claim 30 further comprising a plurality of service modules, separately addressable from and in communication with the application-independent adapter, each service module providing system-wide services to each of the application servers via the application-independent adapter.

40. A method for migrating data from a symmetric multiprocessing data store to a massively parallel processing data store, the method comprising the steps of:
defining a view within the symmetric multiprocessing data store wherein the view refers to a table within the massively parallel processing data store; and
issuing a single data transaction message against the symmetric multiprocessing data store whereby execution of the data transaction message selects records from the symmetric multiprocessing data store and inserts the selected records into a table within the massively parallel processing data store.

41. The method of claim 40 wherein the massively parallel processing data store comprises a plurality of network attached storage devices.

42. The method of claim 41 wherein the table is distributed among more than one of the plurality of network attached storage devices.

43. For use with a system for managing data within a networked computer environment, the system comprising one or more application servers, each capable of running one or more applications thereon, and a plurality of storage devices each in communication with at least one of the application servers and comprising a plurality of physical storage disks for storing data supportive of the applications, a plurality of service modules each separately addressable from and in communication with the application servers and the storage devices, each service module comprising means for providing system-wide services to each of the application servers and each of the storage devices.

44. The service modules of claim 43 wherein the application servers are embedded within adapters between the database management host servers and the plurality of storage devices.

45. The service modules of claim 43 wherein the service modules comprise one or more of a transaction services module, a root services module, a blade services module, a lock manager services module, a catalog service module and a database services module.

46. The service modules of claim 43 further comprising an application-independent adapter residing on the application server and facilitating the transmission of data transaction messages directly to the storage devices.

47. The service modules of claim 46 further comprising an application-specific adapter for facilitating messaging between the applications and the application-independent adapter.

48. The service modules of claim 43 wherein each storage device further comprises query transaction services for processing queries submitted by the application server, the query transaction services comprising query parsing services, query planning services, query execution services and query result aggregation services.

49. The service modules of claim 48 wherein the queries comprise one or more of insert transactions, update transactions, delete transactions and retrieval transactions.

50. The service modules of claim 43 further comprising a separately-addressable transaction recording module for receiving messages from each of the storage devices requesting the creation of a persistent record indicating the completion of a transaction at the storage devices.

51. For use with a system for managing data within a networked computer environment, the system comprising one or more application servers, each capable of running one or more applications thereon, and a plurality of storage devices each in communication with at least one of the application servers and comprising a plurality of physical storage disks for storing data supportive of the applications:
an application-independent adapter residing on the application server and facilitating the transmission of data transaction messages directly to the storage devices; and
an application-specific adapter for facilitating messaging between the applications and the application-independent adapter.

52. The adapters of claim 51 wherein the application-independent adapter is configured to determine a distribution of data among the storage devices, thereby facilitating the delivery of data transaction messages to a storage device having data related to the data transaction message.

53. The adapters of claim 51 wherein the application-independent adapter is configured to combine transaction results received from each of the storage devices.

54. The adapters of claim 51 further comprising a plurality of service modules, separately addressable from and in communication with the application-independent adapter, each service module providing system-wide services to each of the application servers via the application-independent adapter.
